(19) United States
(12) Patent Application Publication
(10) Pub. No.: US 2025/0145768 A1
(43) Pub. Date: May 8, 2025

(54) CROSS-LINKED POLY (ASPARTIC ACID) PRODUCT AND METHOD FOR PRODUCING SAME

(71) Applicant: DIC Corporation, Tokyo (JP)

(72) Inventors: Tomoki Dohi, Sakura-shi (JP); Manabu Kambara, Sakura-shi (JP); Xin Jiang, Qingdao (CN); Qing-Zhang Cui, Qingdao (CN); Jin Guo, Qingdao (CN); Chang-Jun Deng, Qingdao (CN)

(73) Assignee: DIC Corporation, Tokyo (JP)

(21) Appl. No.: 18/838,805

(22) PCT Filed: Nov. 24, 2022
(86) PCT No.: PCT/CN2022/134044

§ 371 Date: Aug. 15, 2024

(30) Foreign Application Priority Data
Feb. 16, 2022 (WO) PCT/CN2022/076421

(51) Int. Cl. C08G 69/48; C08G 69/10; C08G 73/10; C08J 3/075; C08J 3/24

(52) U.S. Cl. CPC C08G 69/48; C08G 69/10; C08G 73/1092; C08J 3/075; C08J 3/24; C08J 2379/08; C08J 2489/00

(57) ABSTRACT

It is an object of the present invention to provide a cross-linked poly(aspartic acid) product that can retain the gel shape, water absorbency, water retentivity, and other performance because it does not undergo hydrolysis over time owing to the absence of an ester bond, and a method for producing the cross-linked poly(aspartic acid) product. The cross-linked poly(aspartic acid) product according to an embodiment of the present invention is a reaction product of a polysuccinimide (PSI), a compound (A: a1-A1-a2) containing a first functional group (a1) and a second functional group (a2), and a polyfunctional epoxy compound (B). The cross-linked poly(aspartic acid) product contains a cross-linked structure (PABAP) represented by PSI-a1-A1-a2-B-a2-A1-a1-PSI, the cross-linked structure (PABAP) is partially hydrolyzed, and the second functional group of the compound (A) does not react with the polysuccinimide (PSI) or is less reactive with the polysuccinimide (PSI) than the first functional group.

This application claims the benefit of PCT Application No. PCT/CN2022/076421, filed Feb. 16, 2022, which is hereby incorporated by reference herein in its entirety.

### TECHNICAL FIELD

The present invention relates to a cross-linked poly(aspartic acid) product and a method for producing the same.

### BACKGROUND ART

Water-absorbent resins are resins capable of absorbing water tens to thousands times their own weights, and are used in a wide range of fields such as sanitary products, disposable diapers, and medical products such as poultices. Typical examples thereof include acrylic acid-based water-absorbent resins, but they are not biodegradable, so disposal (incineration or dumping) after use has become an issue. For this reason, novel water-absorbent resins with biodegradability are strongly demanded.

For example, a method for producing a cross-linked poly(amino acid) by allowing a poly(amino acid) to react with a polyepoxy compound as a cross-linking agent has been disclosed (for example, PTL 1).

A method for producing a polymer using a diamine as a cross-linking agent, the polymer having a poly(aspartic acid) skeleton whose chains are partially cross-linked by the diamine, has been disclosed (for example, PTL 2).

### CITATION LIST

### Patent Literature

### [PTL 1]

Japanese Unexamined Patent Application Publication No. 2000-63511

### [PTL 2]

Japanese Unexamined Patent Application Publication No. 2019-89898

### SUMMARY OF INVENTION

### Technical Problem

In the method described in PTL 1, however, the cross-linking moieties have ester bonds. These ester bonds are hydrolyzed over time, thereby disadvantageously leading to a failure to retain the gel shape.

In the method described in PTL 2, a polar aprotic solvent is used. This requires facilities for handling organic solvents and recovery of organic solvents.

The present invention provides a cross-linked poly(aspartic acid) product that can retain the gel shape, water absorbency, and water retentivity because it does not undergo hydrolysis over time owing to the absence of an ester bond, and a method for producing the cross-linked poly(aspartic acid) product.

### Solution to Problem

The present invention includes the following aspects.
[1] A cross-linked poly(aspartic acid) product is a reaction product of a polysuccinimide (PSI), a compound (A: a1-A1-a2) containing a first functional group (a1) and a second functional group (a2), and a polyfunctional epoxy compound (B), in which the cross-linked poly(aspartic acid) product contains a PSI-a1(A) bond formed by the addition reaction of the first functional group (a1) with the polysuccinimide (PSI), the cross-linked poly(aspartic acid) product contains a B-a2(A) bond formed by the reaction of the second functional group (a2) with the polyfunctional epoxy compound (B), the cross-linked poly(aspartic acid) product contains a cross-linked structure (PABAP) represented by PSI-a1-A1-a2-B-a2-A1-a1-PSI, the cross-linked structure (PABAP) is partially hydrolyzed, and the second functional group of the compound (A) does not react with the polysuccinimide (PSI) or is less reactive with the polysuccinimide (PSI) than the first functional group.
[2] In the cross-linked poly(aspartic acid) product described in [1], the first functional group (a1) is an amino group (NH₂—), the second functional group (a2) is one or more selected from the group consisting of an amino group (NH₂—) and a phosphonooxy group ((OH)₂P(═O)—O—), and when the second functional group (a2) is an amino group (NH₂—), the second functional group is less reactive with the polysuccinimide (PSI) than the first functional group (a1).
[3] In the cross-linked poly(aspartic acid) product described in [1] or [2], the first functional group (a1) is an amino group (NH₂—), the second functional group (a2) is an amino group (NH₂—), and in the compound (A), the amino group of the second functional group (a2) is an amino group in a structure represented by formula (1).

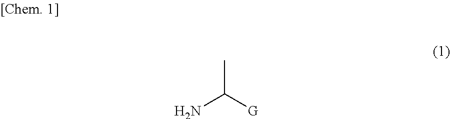

In formula (1), G is a carboxy acid group or its salt.
[4] In the cross-linked poly(aspartic acid) product described in any of [1] to [3], the compound (A) is one or more selected from the group consisting of lysine, ornithine, and arginine.
[5] A water-absorbent composition contains the cross-linked poly(aspartic acid) product described in any of [1] to [4]. [6] A thickening composition contains the cross-linked poly(aspartic acid) product described in any of [1] to [4]. [7] A method for producing a cross-linked poly(aspartic acid) product includes a step of forming a cross-linked product by allowing a polysuccinimide (PSI) to react with a compound (A: a1-A1-a2) containing a first functional group (a1) and a second functional group (a2) and a polyfunctional epoxy compound (B) in water or a water-containing solvent, in which the second functional group of the compound (A) does not react with the polysuccinimide (PSI) or is less reactive with the polysuccinimide (PSI) than the first functional group.
[8] In the method for producing a cross-linked poly(aspartic acid) product described in [7], the first functional group (a1) is an amino group (NH₂—), the second functional group (a2) is one or more selected from the group consisting of an amino group (NH₂—) and a phosphonooxy group ((OH)₂P(═O)—O—), and when the second functional group (a2) is an amino group (NH₂—), the second functional group is less reactive with the polysuccinimide (PSI) than the first functional group (a1).
[9] In the method for producing a cross-linked poly(aspartic acid) product described in [7] or [8], the first functional group (a1) is an amino group (NH₂—), the second functional group (a2) is an amino group (NH₂—), and in the compound (A), the amino group of the first functional group (a1) is an amino group in NH₂—CH₂—, and the amino group of the second functional group (a2) is an amino group in a structure represented by formula (1).

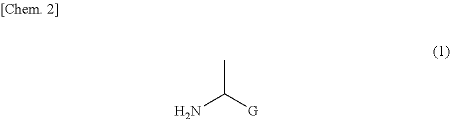

In formula (1), G is a carboxylic acid group or its salt.
[10] In the method for producing a cross-linked poly(aspartic acid) product described in any of [7] to [9], the compound (A) is one or more selected from the group consisting of lysine, ornithine, and arginine.

### Advantageous Effects of Invention

The present invention can provide a cross-linked poly(aspartic acid) product that can retain its gel shape and its water absorbency and water retentivity because it does not undergo hydrolysis over time owing to the absence of an ester bond.

### DESCRIPTION OF EMBODIMENTS

### [Cross-Linked Poly(Aspartic Acid) Product]

A cross-linked poly(aspartic acid) product according to an embodiment of the present invention (hereinafter, also referred to as a “cross-linked product according to the embodiment”) is a reaction product of a polysuccinimide (PSI), a compound (A: a1-A1-a2) containing a first functional group (a1) and a second functional group (a2), and a polyfunctional epoxy compound (B). The cross-linked product contains a PSI-a1(A) bond formed by the addition reaction of the first functional group (a1) with the polysuccinimide (PSI). The cross-linked product contains a B-a2(A) bond formed by the reaction of the second functional group (a2) with the polyfunctional epoxy compound (B). The cross-linked product contains a cross-linked structure (PABAP) represented by PSI-a1-A1-a2-B-a2-A1-a1-PSI. A portion of the cross-linked structure (PABAP) (for example, an unreacted PSI portion) is hydrolyzed. The second functional group of the compound (A) does not react with the polysuccinimide (PSI) or is less reactive with the polysuccinimide (PSI) than the first functional group. [Polysuccinimide (PSI)]

The polysuccinimide (PSI) according to the embodiment is a polymer represented by formula (2) below.

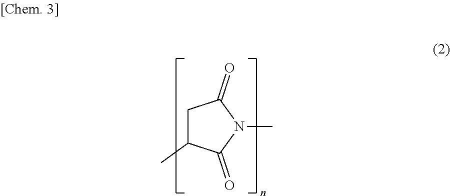

In the formula, n=10 to 10,000.

A method for producing the polysuccinimide (PSI) is not limited to a particular method. For example, the polysuccinimide (PSI) is produced by heating aspartic acid to 170° C. to 190° C. in a vacuum in the presence of phosphoric acid through condensation reaction. To obtain a polysuccinimide having a higher molecular weight, the polysuccinimide produced as described above may be treated with a condensing agent such as dicyclohexylcarbodiimide. The molecular weight of the polysuccinimide is not limited to a particular value. For example, the polysuccinimide preferably has a weight-average molecular weight of 20,000 or more, more preferably 50,000 or more, even more preferably 70,000 or more. The polysuccinimide preferably has a molecular weight of 500,000 or less, more preferably 200,000 or less. In this case, the weight-average molecular weight is a value determined by gel permeation chromatography (GPC) based on polystyrene standards.

### [Compound (A)]

The first functional group (a1) of the compound (A) according to the embodiment is preferably an amino group (NH₂—). The amino group of the first functional group (a1) is more preferably an amino group in NH₂—CH₂—.

The second functional group (a2) of the compound (A) according to the embodiment is preferably an amino group (NH₂—) or a phosphonooxy group ((OH)₂P(═O)—O—). The second functional group (a2) is more preferably an amino group (NH₂—). When the second functional group (a2) is an amino group (NH₂—), the amino group of the second functional group (a2) is even more preferably an amino group in a structure represented by formula (1) below.

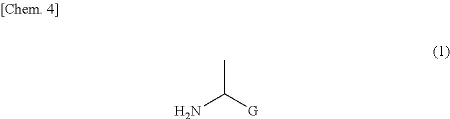

In formula (1), G is a carboxy acid group or its salt.

When G is a salt of a carboxylic acid group, examples of the salt include alkali metal salts, such as sodium salts and potassium salts; alkaline-earth metal salts, such as calcium salts and magnesium salts; organic base salts, such as amine salts; and basic amino acid salts, such as lysine salts and arginine salts. Among these, alkali metal salts are preferred, and sodium salts and potassium salts are more preferred.

In the case where the first functional group (a1) of the compound (A) according to the embodiment is an amino group (NH₂—) and where the second functional group (a2) of the compound (A) according to the embodiment is also an amino group (NH₂—), the amino group of the second functional group of the compound (A) is preferably less reactive with polysuccinimide (PSI) than the amino group of the first functional group. In other words, examples of the compound (A) include diamines each having different terminal structures containing such amino groups. Examples thereof include asymmetric diamines.

In the case where the first functional group (a1) of the compound (A) according to the embodiment is the amino group in NH₂—CH₂— and where the amino group of the second functional group (a2) is the amino group in the structure represented by formula (1) above, an example of the compound (A) is a compound represented by formula (3) below.

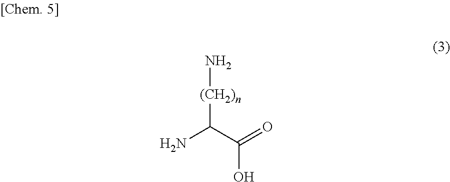

In this formula, n=1 to 10, preferably 2 to 8, more preferably 3 to 5.

The compound (A) according to the embodiment may be a salt of the carboxylic acid group of the compound represented by formula (3) above. In this case, examples of the salt include alkali metal salts, such as sodium salts and potassium salts; alkaline-earth metal salts, such as calcium salts and magnesium salts; organic base salts, such as amine salts; and basic amino acid salts, such as lysine salts and arginine salts. Among these, alkali metal salts are preferred, and sodium salts and potassium salts are more preferred.

In the case where the first functional group (a1) of the compound (A) according to the embodiment is an amino group and where the second functional group (a2) is also an amino group, an example of the compound (A) in which the first functional group (a1) is the amino group in NH₂—CH₂— and the amino group of the second functional group (a2) is the amino group in the structure represented by formula (1) above is a compound represented by formula (4) below.

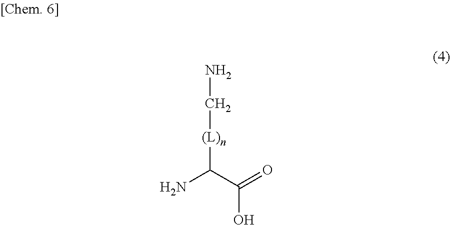

In this formula, L is a divalent linking group, preferably one or more divalent linking groups, such as —CH₂— and C═O, more preferably —CH₂—, and n is an integer of 1 to 10, preferably 2 to 8, more preferably 3 to 5.

The compound (A) according to the embodiment may be a salt of the carboxylic acid group of the compound represented by formula (4) above. In this case, examples of the salt include alkali metal salts, such as sodium salts and potassium salts; alkaline-earth metal salts, such as calcium salts and magnesium salts; organic base salts, such as amine salts; and basic amino acid salts, such as lysine salts and arginine salts. Among these, alkali metal salts are preferred, and sodium salts and potassium salts are more preferred.

In the case where the first functional group (a1) of the compound (A) according to the embodiment is an amino group and where the second functional group (a2) is a phosphonooxy group ((OH)₂P(═O)—O—) group, an example of the compound (A) is a compound represented by formula (5) below.

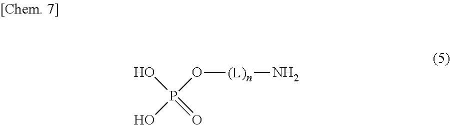

In this formula, L is a divalent linking group, preferably one or more divalent linking groups, such as —CH₂— and C═O, more preferably —CH₂—, and n is an integer of 1 to 10, preferably 2 to 8, more preferably 3 to 5.

The compound (A) according to the embodiment may be a salt of the phosphonooxy group of the compound represented by formula (5) above. In this case, examples of the salt include alkali metal salts, such as sodium salts and potassium salts; alkaline-earth metal salts, such as calcium salts and magnesium salts; organic base salts, such as amine salts; and basic amino acid salts, such as lysine salts and arginine salts. Among these, alkali metal salts are preferred, and sodium salts and potassium salts are more preferred.

Examples of the compound (A) according to the embodiment include lysine, ornithine, and arginine.

When the compound (A) according to the embodiment contains an amino group, an acidic salt of the compound (A) may be used as a raw material. Examples of the acidic salt of the compound (A) include hydrochlorides, such as lysine hydrochloride, ornithine hydrochloride, and arginine hydrochloride, and similar sulfates.

As the compound (A) according to the embodiment, a dipeptide can be used. Examples of the dipeptide include dipeptides each having a basic amino acid residue at the C-terminus, such as glycine-lysine (isopeptide bond), alanine-lysine (isopeptide bond), glycine-ornithine (isopeptide bond), and alanine-ornithine (isopeptide bond); and dipeptides each having a basic amino acid residue at the N-terminus, such as lysine-glycine, lysine-alanine, ornithine-glycine, and ornithine-alanine.

For example, glycine-lysine is a dipeptide represented by formula (6) below, and lysine-glycine is a dipeptide represented by formula (7) below.

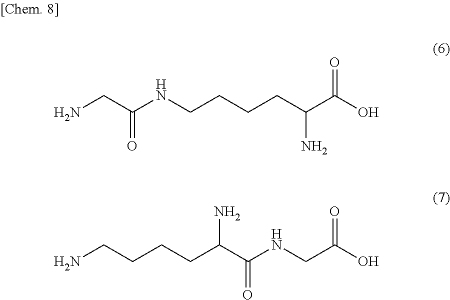 [SMILES: NCC(=O)NCCCCC(N)C(=O)O ; NCCCCC(N)C(=O)NCC(=O)O]

### [Polyfunctional Epoxy Compound (B)]

Examples of the polyfunctional epoxy compound according to the embodiment include polyglycidyl ethers of (C2-C6)alkane polyols and poly(alkylene glycols), such as ethylene glycol diglycidyl ether, diethylene glycol diglycidyl ether, polyethylene glycol diglycidyl ether, glycerol diglycidyl ether, glycerol triglycidyl ether, diglycerol polyglycidyl ether, polyglycerol polyglycidyl ether, propylene glycol diglycidyl ether, and butanediol diglycidyl ether; (C4-C8)diepoxyalkanes and diepoxyalkanes, such as sorbitol polyglycidyl ether, pentaerythritol polyglycidyl ether, erythritol polyglycidyl ether, trimethylolethane polyglycidyl ether, trimethylolpropane polyglycidyl ether, 1,2,3,4-diepoxybutane, 1,2,4,5-diepoxypentane, 1,2,5,6-diepoxyhexane, 1,2,7,8-diepoxyoctane, 1,4- and 1,3-divinylbenzene epoxides; and (C6-C15) polyphenol polyglycidyl ethers, such as 4,4′-isopropylidene diphenol diglycidyl ether (also known as bisphenol A diglycidyl ether) and hydroquinone diglycidyl ether.

Further examples thereof include polyfunctional epoxy compounds, available from Nagase ChemteX Corporation, such as EX-810, EX-861, EX-313, EX-614B, and EX-512.

### [Method for Producing Cross-Linked Poly(Aspartic Acid) Product]

A method according to the embodiment for producing a cross-linked poly(aspartic acid) product (hereinafter, also referred to as a “production method according to the embodiment”) includes a step of forming a cross-linked product by allowing a polysuccinimide (PSI) to react with a compound (A: a1-A1-a2) containing a first functional group (a1) and a second functional group (a2) and a polyfunctional epoxy compound (B) in water or a water-containing solvent. The polysuccinimide (PSI), the compound (A) containing the first functional group (a1) and the second functional group (a2), and the polyfunctional epoxy compound (B) are the same as those described in the cross-linked poly(aspartic acid) product according to the embodiment. Preferred examples thereof are also the same.

In the production method according to the embodiment, the order of reaction of the polysuccinimide (PSI), the compound (A), and the polyfunctional epoxy compound (B) is not limited to any specific order. Examples thereof include three production methods below.
(i) A production method that includes the steps of allowing the polysuccinimide (PSI) to react with the compound (A) to obtain a reaction product (P1) of the polysuccinimide (PSI) and the compound (A), and allowing the reaction product (P1) obtained in the above step to react with the polyfunctional epoxy compound (hereinafter, referred to as “method (i)”).
(ii) A production method in which the polysuccinimide (PSI) and the compound (A) are first mixed, and then the polyfunctional epoxy compound is added thereto at a constant rate while the reaction is allowed to proceed (hereinafter, referred to as “method (ii)”).
(iii) A production method in which the polysuccinimide (PSI), the compound (A), and the polyfunctional epoxy compound are mixed together and then reacted (hereinafter, referred to as “method (iii)”).

From the viewpoint of easily controlling the structure of the resulting cross-linked poly(aspartic acid) product, method (i) or method (ii) is preferred. Method (i) is more preferred.

The production method according to the embodiment will be described in detail by taking method (i) above as an example.

In the step of producing the reaction product (P1) in method (i), the compound (A) is preferably dissolved in water first. For example, water is preferably used in an amount of 5 to 50 parts by mass, more preferably 7 to 15 parts by mass, based on 1 part by mass of the compound (A). The aqueous solution is mixed with the polysuccinimide. With regard to the mixing ratio, the compound (A) is preferably used in an amount of 0.5 to 10 parts by mass, more preferably 1 to 5 parts by mass, even more preferably 1.5 to 3 parts by mass, based on 10 parts by mass of the polysuccinimide.

In the mixture after feeding, an organic or inorganic base compound, such as NaOH or amine, is added to adjust the pH of the aqueous solution to preferably 8 to 13, more preferably 9 to 12. In the obtained product, the percentage of compound (A)-added units is preferably 2% to 30%, more preferably 5% to 15%, even more preferably 8% to 12%, of the total units. The percentage of the compound (A)-added units can be determined from the ratio (Ib/Ia) of the integral value Ib of a peak originating from the protons of —CH₂— in the compound (A) to the integral value Ia of a peak originating from the protons of —CH₂— in the poly(aspartic acid) main-chain skeleton in proton NMR. Alternatively, the percentage of the compound (A)-added units can be determined from the ratio of a value twice the integral value Ic of a peak originating from the proton of —CH— in the compound (A) to the integral value Ia (Ic×2/Ia).

In the step of allowing the reaction product (P1) to react with the polyfunctional epoxy compound in method (i), the feeding amount of the polyfunctional epoxy compound is preferably 2 to 10 parts by mass, more preferably 3 to 8 parts by mass, based on 100 parts by mass of the reaction product (P1).

As the reaction product (P1), the reaction product (P1) in solid form, which is obtained by isolating the reaction product (P1) from the reaction solution prepared in the step of forming the reaction product (P1), can be used. In this case, the aqueous solution of the reaction product (P1) is preferably prepared in advance before the addition of the polyfunctional epoxy compound.

As the reaction product (P1), the polyfunctional epoxy compound can be added to the reaction solution without isolating the reaction product (P1) from the reaction solution prepared in the step of forming the reaction product (P1).

The temperature of the reaction between the reaction product (P1) and the polyfunctional epoxy compound can be 30° C. to 100° C. and is preferably 40° C. to 80° C., more preferably 50° C. to 70° C. The reaction time can be, for example, 40 to 600 minutes and is preferably 60 to 300 minutes, at 60° C.

To isolate the cross-linked poly(aspartic acid) product formed by the reaction, the commonly known and usual isolation operations, such as recrystallization, reprecipitation, filtration, and concentration, can be used.

The size (average particle size) of the cross-linked poly(aspartic acid) product is preferably, but not necessarily, 150 μm or less, more preferably 100 μm or less, even more preferably 80 μm or less, for example, for thickening composition applications. For example, in the applications of “water-absorbent compositions” intended for diapers and sanitary products, the size is preferably in the range of 1 to 5,000 μm, more preferably 10 to 1,000 μm, even more preferably 100 to 800 μm.

### [Degree of Crosslinking]

The amounts of the compound (A) and the polyfunctional epoxy compound (B) used with respect to the polysuccinimide (PSI) according to the embodiment may be appropriately selected in accordance with the desired degree of crosslinking. For example, in the case of the production method using method (i) described above, the degree of crosslinking can be controlled by adjusting the mixing ratio of the polysuccinimide (PSI) to the compound (A) in the range described above and also by adjusting the polyfunctional epoxy compound (B). The percentage of the compound (A)-added units (addition percentage) depends on the application of the finally formed cross-linked poly(aspartic acid) product. For example, in applications that require high levels of water absorbency and water retentivity, the percentage of the compound (A)-added units (addition percentage) is preferably 1% to 20%, more preferably 3% to 15%, even more preferably 5% to 10% of the total units in the polysuccinimide (PSI). The addition percentage can be measured by NMR.

### [Application of Cross-Linked Poly(Aspartic Acid) Product]

The cross-linked poly(aspartic acid) product according to the embodiment can be used as a water-absorbent composition included in the absorbent material of an absorbent article, such as a diaper or sanitary product. When the cross-linked poly(aspartic acid) product according to the embodiment is used as the water-absorbent composition described above, the size (average particle size) is preferably 1 to 5,000 μm, more preferably 10 to 1,000 μm, even more preferably 100 to 800 μm.

The cross-linked poly(aspartic acid) product according to the embodiment can also be used as a thickening composition. When the cross-linked poly(aspartic acid) product according to the embodiment is used as the thickening composition described above, the size (average particle size) is preferably 150 μm or less, more preferably 100 μm or less, even more preferably 80 μm or less.

### [Water-Absorbent Resin]

A water-absorbent resin according to an embodiment (the embodiment) of the present invention contains the cross-linked poly(aspartic acid) product according to the embodiment. The water-absorbent resin according to the embodiment may contain, for example, another resin or another known additive other than the cross-linked poly(aspartic acid) product according to the embodiment, as needed.

When the cross-linked poly(aspartic acid) product according to the embodiment is a hydrogel-like cross-linked product, the cross-linked product is dried, as needed, and usually pulverized before or after drying to form a water-absorbent resin. The drying method is not limited to a particular method and can be freely selected from known methods, such as heat drying, freeze drying, drying under reduced pressure (in a vacuum), and heat drying under reduced pressure. The drying method may change the particle shape and thus is selected according to the purpose. In the case of the heat drying, the drying temperature is usually in the range of 60° C. to 250° C., preferably 80° C. to 220° C., more preferably 100° C. to 200° C. In the case of the heat drying under reduced pressure, the drying temperature is usually in the range of 50° C. to 200° C., preferably 60° C. to 150° C., more preferably 70° C. to 120° C. The drying time varies in accordance with the surface area and the water content of the hydrogel-like cross-linked product, and the type of dryer, and is selected so as to achieve the desired water content. It is difficult to reduce the water content of water-absorbent resin to zero. Thus, when a water-absorbent resin containing a small amount of water (for example, 0.3% to 15% by weight, even 0.5% to 10% by weight) can be treated as a powder, the water-absorbent resin containing such a small amount of water is also referred to as a water-absorbent resin in this specification. The water-absorbent resin according to the embodiment preferably has a cross-linked poly(aspartic acid) product content of 50% by mass to 100% by mass, more preferably 70% by mass to 100% by mass, even more preferably 90% by mass to 100% by mass. The water-absorbent resin according to the embodiment may be the cross-linked poly(aspartic acid) product according to the embodiment.

### [Water-Absorbent Resin Particles]

Water-absorbent resin particles according to an embodiment (the embodiment) of the present invention contain the water-absorbent resin according to the embodiment.

Examples of the shape of the water-absorbent resin particles according to the embodiment include substantially spherical shapes, crushed shapes, and granular shapes. The water-absorbent resin particles according to the embodiment preferably have a size (average particle size) of 1 μm to 5,000 μm, more preferably 10 μm to 1,000 μm, even more preferably 100 μm to 800 μm. The particle size distribution of the water-absorbent resin particles may be adjusted by performing an operation, such as particle size adjustment using classification with a sieve.

In the water-absorbent resin particles according to the embodiment, cross-linking (surface cross-linking) of the surface portion of the hydrogel-like cross-linked product can be performed using a cross-linking agent. The surface cross-linking facilitates control of the water absorption characteristics of the water-absorbent resin particles. The surface cross-linking is preferably performed at a time when the hydrogel-like cross-linked product has a specific water content.

An example of the cross-linking agent for surface cross-linking (surface cross-linking agent) is a cross-linking agent used for the production of the cross-linked poly(aspartic acid) product according to the embodiment. Other compounds each having two or more reactive functional groups can also be exemplified. The cross-linking agents may be used alone or in combination of two or more.

After the surface cross-linking, water or a water-containing solvent is evaporated by a known method to provide cross-linked product particles as a dry product with a cross-linked surface.

The water-absorbent resin particles according to the embodiment may consist only of the cross-linked product particles and may further contain various additional components selected from, for example, gel stabilizers, metal chelating agents, and fluidity improvers (lubricants). The additional components may be disposed inside the cross-linked product particles, on the surfaces of the cross-linked product particles, or both. As the additional components, fluidity improvers (lubricants) are preferred. Of these, inorganic particles are more preferred. Examples of the material of the inorganic particles include silica particles, such as amorphous silica, talc, and mica.

The water-absorbent resin particles may contain multiple inorganic particles disposed on the surfaces of the cross-linked product particles. For example, the inorganic particles can be arranged on the surfaces of cross-linked product particles by mixing the cross-linked product particles with the inorganic particles. The inorganic particles may be silica particles composed of, for example, amorphous silica. When the water-absorbent resin particles contain the inorganic particles disposed on the surfaces of the cross-linked product particles, the proportion of the inorganic particles may be 0.2% or more by mass, 0.5% or more by mass, 1.0% or more by mass, or 1.5% or more by mass, and may be 5.0% or less by mass or 3.5% or less by mass, based on the mass of the cross-linked product particles. When the amount of inorganic particles added is within the above range, it is easy to obtain water-absorbent resin particles having suitable water absorption characteristics.

### [Absorbent Material]

An absorbent material according to an embodiment (the embodiment) of the present invention includes the water-absorbent resin particles and a fibrous layer containing a fibrous material. The absorbent material is, for example, a mixture containing the water-absorbent resin particles and the fibrous material. Examples of the configuration of the absorbent material may include a uniform mixture of the water-absorbent resin particles and the fibrous material; a configuration in which the water-absorbent resin particles are interposed between sheets or layers composed of the fibrous material; and other configurations.

The proportion by mass of the water-absorbent resin particles in the absorbent material according to the embodiment may be 2% to 100% by mass, 10% to 90% by mass, or 10% to 80% by mass, based on the total of the water-absorbent resin particles and the fibrous material.

The shape of the absorbent material according to the embodiment is not limited to a particular shape, and may be, for example, a sheet-like, tubular, film-like, or fibrous shape. The absorbent material (for example, a sheet-like absorbent material) may have a thickness of, for example, 0.1 mm to 50 mm, or 0.3 mm to 30 mm.

The absorbent material according to the embodiment contains the water-absorbent resin particles according to the embodiment. The absorbent material according to the embodiment may further contain other known water-absorbent resin particles in addition to the water-absorbent resin particles according to the embodiment. The absorbent material according to the embodiment preferably contains only the water-absorbent resin particles according to the embodiment as the water-absorbent resin particles.

The absorbent material according to the embodiment preferably has a water-absorbent resin particle content of 50 g to 2,000 g per square meter of the absorbent material (that is, 50 g to 2,000 g/m2), more preferably 100 g to 1,000 g/m2, from the viewpoint of more easily obtaining sufficient liquid absorption performance when the absorbent material is used in an absorbent article described below. The water-absorbent resin particle content is preferably 50 g/m2 or more from the viewpoints of providing sufficient liquid absorption performance as an absorbent article and, in particular, suppressing liquid leakage. From the viewpoints of suppressing the gel blocking phenomenon, providing the liquid diffusion performance of the absorbent article, and improving the liquid penetration rate, the water-absorbent resin particle content is preferably 2,000 g/m2 or less.

### [Fibrous Material]

Non-limiting examples of the fibrous material include finely pulverized wood pulp; cotton; cotton linters; rayon; wool; acetate; vinylon; cellulose fibers, such as cellulose acetate; synthetic fibers, such as polyamide, polyester, and polyolefin; and mixtures of these fibers. These fibrous materials may be used alone or in combination of two or more. As the fibrous material, hydrophilic fibers can be used.

The fibrous material content is preferably 50 g to 800 g per square meter of the absorbent material (that is, 50 g/m2 to 800 g/m2), more preferably 100 g/m2 to 600 g/m2, even more preferably 150 g/m2 to 500 g/m2, from the viewpoint of obtaining sufficient liquid absorption performance even when the absorbent material is used in an absorbent article described below. The fibrous material content is preferably 50 g or more per square meter of the absorbent material (that is, 50 g/m2 or more) from the viewpoints of providing sufficient liquid absorption performance as an absorbent article, in particular, suppressing the occurrence of a gel blocking phenomenon to enhance liquid diffusion performance, and further enhancing the strength of the absorbent material after liquid absorption. In particular, from the viewpoint of suppressing reversion after liquid absorption, the fibrous material content is preferably 800 g or less per square meter of the absorbent material (that is, 800 g/m2 or less).

To enhance the shape retention before and during use of the absorbent material, the fibers may be bonded to each other by adding an adhesive binder to the fibrous material. Examples of the adhesive binder include heat-fusible synthetic fibers, hot-melt adhesives, and adhesive emulsions. These adhesive binders may be used alone or in combination of two or more.

Examples of heat-fusible synthetic fibers include full-melt binders, such as polyethylene, polypropylene, and ethylene-propylene copolymers; and non-full-melt binders each having a side-by-side structure or core-sheath structure of polypropylene and polyethylene. In the non-full-melt binders described above, only polyethylene portions can be heat-fused.

Examples of hot-melt adhesives include mixtures of a base polymer, such as an ethylene-vinyl acetate copolymer, a styrene-isoprene-styrene block copolymer, a styrene-butadiene-styrene block copolymer, a styrene-ethylene-butylene-styrene block copolymer, a styrene-ethylene-propylene-styrene block copolymer, or an amorphous polypropylene, with a tackifier, a plasticizer, or an antioxidant.

Examples of adhesive emulsions include polymers of at least one monomer selected from the group consisting of methyl methacrylate, styrene, acrylonitrile, 2-ethylhexyl acrylate, butyl acrylate, butadiene, ethylene, and vinyl acetate.

### [Additives]

The absorbent material according to the embodiment may further contain various additives, such as inorganic powders, deodorants, pigments, dyes, fragrances, antibacterial agents, and adhesives, all of which are commonly used in the technical field. These additives can impart various functions to the absorbent material. Examples of the inorganic powders include silicon dioxide, zeolite, mica, kaolin, and clay. When the water-absorbent resin particles contain inorganic particles, the absorbent material may contain the inorganic powder in addition to the inorganic particles in the water-absorbent resin particles.

### [Absorbent Article]

An absorbent article according to an embodiment (the embodiment) of the present invention includes an absorbent material, a liquid-permeable sheet disposed at the outermost portion on the inflow side of a target liquid to be absorbed, a liquid-impermeable sheet disposed at the outermost portion on a side opposite to the inflow side of the target liquid to be absorbed. Examples of the absorbent article include diapers (for example, disposable diapers), toilet training pants, incontinence pads, urine absorbent sheets, urine absorbent liners, hygiene products, such as sanitary napkins and tampons, sweat pads, pet sheets, portable toilet members, and animal excrement treatment materials.

In the absorbent article, the liquid-impermeable sheet, the absorbent material, and the liquid-permeable sheet are laminated in this order.

The absorbent article according to the embodiment includes the absorbent material according to the embodiment. The absorbent article according to the embodiment may include another known absorbent material in addition to the absorbent according to the embodiment. The absorbent article according to the embodiment preferably includes only the absorbent material according to the embodiment as an absorbent material.

### [Liquid-Permeable Sheet]

The liquid-permeable sheet is disposed at the outermost portion on the inflow side of the target liquid to be absorbed. The liquid-permeable sheet has, for example, a main surface wider than the absorbent material. The outer edge portion of the liquid-permeable sheet extends around the absorbent material.

The liquid-permeable sheet may be a sheet formed from a resin or fibers commonly used in the technical field. From the viewpoints of liquid permeability, flexibility, and strength when the liquid-permeable sheet is used in an absorbent article, the liquid-permeable sheet may contain a synthetic resin, for example, a polyolefin, such as polyethylene (PE) or polypropylene (PP), a polyester, such as poly(ethylene terephthalate) (PET), poly(trimethylene terephthalate) (PTT), poly(ethylene naphthalate) (PEN), poly(butylene adipate terephthalate) (PBAT), poly(butylene succinate) (PBS), poly(butylene succinate adipate) (PBSA), poly(lactic acid), or polyhydroxyalkanoate, a polyamide, such as nylon, or rayon. The liquid-permeable sheet may contain synthetic fibers containing one or more of those synthetic resins or may contain natural fibers containing cotton, silk, hemp, or pulp (cellulose). From the viewpoint of, for example, increasing the strength of the liquid-permeable sheet, the liquid-permeable sheet may contain synthetic fibers. The synthetic fibers may, in particular, be polyolefin fibers, polyester fibers, or a combination thereof. These materials may be used alone or in combination of two or more thereof.

The liquid-permeable sheet may be a nonwoven fabric, a porous sheet, or a combination thereof. The nonwoven fabric is a sheet in which fibers are entangled instead of being woven. The nonwoven fabric may be a non-woven fabric (short-fiber nonwoven fabric) composed of short fibers (that is, staples) or may be a nonwoven fabric (long-fiber nonwoven fabric) composed of long fibers (that is, filaments). The staples may have a fiber length of typically, but not limited to, several hundred millimeters or less.

The liquid-permeable sheet may be at least one nonwoven fabric selected from the group consisting of thermally bonded nonwoven fabrics, air-through nonwoven fabrics, resin-bonded nonwoven fabrics, spunbond nonwoven fabric, meltblown nonwoven fabric, spunbond/meltblown/spunbond nonwoven fabrics, air laid nonwoven fabrics, spunlace nonwoven fabrics, and point bonded nonwoven fabrics. The liquid-permeable sheet is preferably at least one nonwoven fabric selected from the group consisting of thermally bonded nonwoven fabrics, air-through nonwoven fabrics, spunbond nonwoven fabrics, and spunbond/meltblown/spunbond nonwoven fabrics.

The liquid-permeable sheet may be a thermally bonded nonwoven fabric, an air-through nonwoven fabric, a resin-bonded nonwoven fabric, a spunbond nonwoven fabric, a meltblown nonwoven fabric, an air-laid nonwoven fabric, a spunlace nonwoven fabric, a point bonded nonwoven fabric, or a laminate of two or more nonwoven fabrics selected therefrom. These nonwovens can be formed of the synthetic fibers or natural fibers described above. The laminate of two or more nonwoven fabrics may be, for example, a spunbond/meltblown/spunbond nonwoven fabric that is a composite nonwoven fabric including a spunbond nonwoven fabric, a meltblown nonwoven fabric, and a spunbond nonwoven fabric laminated in this order. Among these, from the viewpoint of suppressing liquid leakage, a thermally bonded nonwoven fabric, an air-through nonwoven fabric, a spunbond nonwoven fabric, or a spunbond/meltblown/spunbond nonwoven fabric is preferably used.

The nonwoven fabric used as the liquid-permeable sheet preferably has appropriate hydrophilicity from the viewpoint of the liquid absorption performance of the absorbent article.

The nonwoven fabric having hydrophilicity as described above may be formed of, for example, a fiber exhibiting an appropriate degree of hydrophilicity, such as rayon fibers, or may be formed of fibers obtained by subjecting a hydrophobic chemical fibers, such as polyolefin fibers or polyester fibers, to hydrophilization treatment. Examples of a method for obtaining a nonwoven fabric containing hydrophobic chemical fibers that have been subjected to hydrophilization treatment include a method in which a nonwoven fabric is obtained by a spunbond method using hydrophobic chemical fibers mixed with a hydrophilizing agent, a method in which a spunbond nonwoven fabric is produced using hydrophobic chemical fibers in the presence of a hydrophilization agent, and a method in which a spunbond nonwoven fabric obtained using hydrophobic chemical fibers is impregnated with a hydrophilizing agent. Examples of the hydrophilizing agent include anionic surfactants, such as aliphatic sulfonates and higher alcohol sulfates, cationic surfactants, such as quaternary ammonium salts, nonionic surfactants, such as polyethylene glycol fatty acid esters, polyglycerol fatty acid esters, and sorbitan fatty acid esters, silicone surfactants, such as polyoxyalkylene-modified silicones, and stain release agents composed of a polyester-based resin, a polyamide-based resin, an acrylic resin, or a urethane-based resin.

The liquid-permeable sheet is preferably a nonwoven fabric that is appropriately bulky and that has a large weight per unit area from the viewpoints of imparting good liquid permeability, flexibility, strength, and cushioning properties to the absorbent article and from the viewpoint of increasing the liquid permeation rate of the absorbent article.

### [Liquid-Impermeable Sheet]

The liquid-impermeable sheet is disposed at the outermost portion on the opposite side of the absorbent article from the liquid-permeable sheet. The liquid-impermeable sheet has, for example, a main surface wider than the absorbent material. The outer edge portion of the liquid-impermeable sheet extends around the absorbent material. The liquid impermeable sheet prevents leakage of a liquid that has been absorbed in the absorbent material from the liquid-impermeable sheet side to the outside.

Examples of the liquid-impermeable sheet include a sheet composed of a resin, such as polyethylene, polypropylene, poly(vinyl chloride), poly(lactic acid), or polyhydroxyalkanoate; a sheet composed of a nonwoven fabric, such as a spunbond/meltblown/spunbond (SMS) nonwoven fabric in which a water-resistant meltblown nonwoven fabric is interposed between high-strength spunbond nonwoven fabric layers; and a sheet composed of a composite material of one or more of those resins and a nonwoven fabric, such as a spunbond nonwoven fabric or a spunlace nonwoven fabric. The liquid-impermeable sheet is preferably breathable from the viewpoint of, for example, reducing dampness during wearing to reduce discomfort to a wearer. As the liquid-impermeable sheet, a sheet composed of a synthetic resin mainly containing a low-density polyethylene (LDPE) resin can be used.

The size relationship among the absorbent material, the liquid-permeable sheet, and the liquid-impermeable sheet is not particularly limited, and is appropriately adjusted in accordance with, for example, the use of the absorbent article.

### EXAMPLES

While the present invention will be described in more detail below by examples, the present invention is not limited to these examples.

Raw materials, apparatuses, and so forth used in these examples of the present invention will be described below.

### [Raw Material]

Aspartic acid: available from Yixing Qiancheng Bio-Engineering Co., Ltd., purity: 99.97%
Phosphoric acid: available from Kanto Chemical Co., Inc., purity: 85%
L-Lysine: available from Tokyo Chemical Industry Co., Ltd., purity: 97%
L-Ornithine monohydrochloride: available from Kanto Chemical Co., Inc., purity: 98%
Phosphorylethanolamine: available from Tokyo Chemical Industry Co., Ltd., purity: 98%
Hexamethylenediamine: available from Kanto Chemical Co., Inc., purity: 98%
Polyfunctional epoxy compound: available from Nagase ChemteX Corporation, EX-810

### [Evaluation Method]

[Measurement of Weight-Average Molecular Weight of polysuccinimide]

The weight-average molecular weight of the polysuccinimide was determined by a GPC method (differential refractometer) in terms of polystyrene. A G1000HHR column, a G4000HHR column, and a GMHHR-H column (TSKgel (registered trademark), available from Tosoh Corporation) were used for the measurement. Dimethylformamide containing 10 mM lithium bromide was used as an eluent.

### [Evaluation of Water Absorbency]

The water absorbency was evaluated in accordance with a tea bag method (JIS K-7223) using physiological saline. The water absorption capacity was calculated from the following formula.

Water absorption capacity [g-water/g]={(weight after water absorption)−(blank weight after water absorption)−(sample weight)}/(sample weight)

### [Evaluation of Water Retentivity]

For the evaluation of the water retentivity, after evaluating the water absorption capacity by the tea bag method, the bag was dehydrated in a centrifugal dehydrator at 25° C., 150G×2 minutes. Then the weight of the dehydrated tea bag was measured. The water retention capacity was calculated by the following formula.

Water retention capacity [g-water/g]={(weight after dehydration)−(blank weight after dehydration)−(sample weight)}/(sample weight)

### [Evaluation of Elastic Modulus]

The elastic modulus was measured with an MCR-102 rotational rheometer (available from AntonPaar) at angular frequencies of 0.1 to 100 (rad/s) using PP-25 parallel plates with a gap of 2 mm at a measurement temperature of 25° C. The storage elastic modulus at an angular frequency of 1.0 (rad/s) was used.

### Synthesis Example 1

### [Synthesis of Polysuccinimide]

In a mortar, 160 parts of aspartic acid and 83 parts of 85% phosphoric acid were mixed together. The mixture was transferred to a tray. The reaction was performed at 190° C. and 1.3 kPa for 6 hours. The reaction mixture was pulverized, washed with distilled water until the filtrate was neutral, and dried in vacuum at 80° C. to give 115 parts of polysuccinimide having a weight-average molecular weight of 70,000.

### Example 1

### [Synthesis of Cross-Linked Poly(Aspartic Acid) Product]

### [Synthesis of Reaction Product (P1) of PSI and Compound (A)]

First, 2.23 parts of L-lysine was added to 20 parts of distilled water and dissolved under stirring, and then 10 parts of polysuccinimide prepared in Synthesis example 1 was added thereto. While adjusting the pH to 10 to 11, 9.75 parts of a 36% aqueous NaOH solution was added dropwise under stirring at room temperature. After the completion of the dropwise addition, the mixture was stirred for another 15 hours at room temperature. The resulting reaction solution was filtered through a nylon mesh filter with 59-μm openings to give a lysine-added sodium polyaspartate solution (solid content: 43%). NMR analysis revealed that the percentage of lysine-added units was 9.2% of the total units.

### [Synthesis of Cross-Linked Product]

First, 4.64 parts of the lysine-added sodium polyaspartate solution prepared in the above step was mixed with 0.106 parts of an EX-810 polyfunctional epoxy compound (available from Nagase ChemteX Corporation), and the mixture was heated and reacted at 60° C. The elastic modulus measurement at every predetermined reaction time indicated a storage elastic modulus of 1,100 Pa at a reaction time of 60 minutes and a storage elastic modulus of 1,180 Pa at a reaction time of 180 minutes. After a reaction time of 180 minutes, the gel shape was maintained.

The gel composition obtained at a reaction time of 180 minutes was freeze-dried. The dry composition was ground in a mortar and sifted with a stainless steel sieve (JIS Z-8801) so as to have a particle size of 150 to 710 μm. The water absorbency and the water retentivity were measured to be 45.5 g/g and 29.1 g/g, respectively.

### Example 2

### [Synthesis of Cross-Linked Poly(Aspartic Acid) Product]

### [Synthesis of Reaction Product of PSI and Compound (A)]

First, 2.61 parts of L-ornithine monohydrochloride and 1.29 parts of a 48% aqueous NaOH solution were added to 19.3 parts of distilled water and dissolved under stirring, and then 10 parts of polysuccinimide prepared in Synthesis example 1 was added thereto. While adjusting the pH to 11 to 12, 9.72 parts of a 36% aqueous NaOH solution was added dropwise under stirring at room temperature. After the completion of the dropwise addition, the mixture was stirred for another 15 hours at room temperature. The resulting reaction solution was filtered through a nylon mesh filter with 59-μm openings to give an ornithine-added sodium polyaspartate solution (solid content: 50%). NMR analysis revealed that the percentage of ornithine-added units was 10.1% of the total units.

### [Synthesis of Cross-Linked Product]

First, 5.73 parts of the ornithine-added sodium polyaspartate solution prepared in the above step was mixed with 0.148 parts of an EX-810 polyfunctional epoxy compound (available from Nagase ChemteX Corporation), and the mixture was heated and reacted at 60° C. The elastic modulus measurement at every predetermined reaction time indicated a storage elastic modulus of 680 Pa at a reaction time of 60 minutes and a storage elastic modulus of 730 Pa at a reaction time of 180 minutes. After a reaction time of 180 minutes, the gel shape was retained.

The gel composition obtained at a reaction time of 180 minutes was freeze-dried. The dry composition was ground in a mortar and sifted with a stainless steel sieve (JIS Z-8801) so as to have a particle size of 150 to 710 μm. The water absorbency and the water retentivity were measured to be 46.0 g/g and 31.2 g/g, respectively.

### Example 3

### [Synthesis of Reaction Product of PSI and Compound (A)]

First, 2.18 parts of phosphorylethanolamine and 1.29 parts of a 48% aqueous NaOH solution were added to 19.3 parts of distilled water and dissolved under stirring, and then 10 parts of polysuccinimide prepared in Synthesis example 1 was added thereto. While adjusting the pH to 11 to 12, 9.72 parts of a 36% aqueous NaOH solution was added dropwise under stirring at room temperature. After the completion of the dropwise addition, the mixture was stirred for another 15 hours at room temperature. The resulting reaction solution was filtered through a nylon mesh filter with 59-μm openings to give a phosphorylethanolamine-added sodium polyaspartate solution (solid content: 38%). NMR analysis revealed that the percentage of phosphorylethanolamine-added units was 5.5% of the total units.

### [Synthesis of Cross-Linked Product]

First, 5.50 parts of the phosphorylethanolamine-added sodium polyaspartate solution prepared in the above step was mixed with 0.445 parts of an EX-810 polyfunctional epoxy compound (available from Nagase ChemteX Corporation), and the mixture was heated and reacted at 60° C. The elastic modulus measurement at every predetermined reaction time indicated a storage elastic modulus of 1,250 Pa at a reaction time of 60 minutes and a storage elastic modulus of 1,310 Pa at a reaction time of 180 minutes. After a reaction time of 180 minutes, the gel shape was retained.

The gel composition obtained at a reaction time of 180 minutes was freeze-dried. The dry composition was ground in a mortar and sifted with a stainless steel sieve (JIS Z-8801) so as to have a particle size of 150 to 710 μm. The water absorbency and the water retentivity were measured to be 40.8 g/g and 29.0 g/g, respectively.

### Comparative Example 1

The polysuccinimide prepared in Synthesis example 1 was hydrolyzed with an aqueous sodium hydroxide solution to prepare an aqueous solution of sodium polyaspartate (solid content: 30%). Hydrochloric acid was added to 5.43 parts of the resulting aqueous solution of sodium polyaspartate to adjust the pH to 5.0. Then, 0.135 parts of an EX-810 polyfunctional epoxy compound (available from Nagase ChemteX Corporation) was mixed, and the mixture was heated and reacted at 60° C. The elastic modulus measurement at every predetermined reaction time indicated a storage elastic modulus of 42.2 Pa at a reaction time of 60 minutes, a storage elastic modulus of 1,510 Pa at a reaction time of 120 minutes, and a storage elastic modulus of 6.71 Pa at a reaction time of 180 minutes. After a reaction time of 180 minutes, the product was in a liquid state with high fluidity and did not retain its gel shape. The reason for this is presumably that because the cross-linking moieties of the product were ester bonds, the product was de-crosslinked.

### Comparative Example 2

Two parts of the polysuccinimide prepared in Synthesis example 1 was added to 20 parts of distilled water, and then the mixture was stirred to prepare a polysuccinimide dispersion. A mixture of 0.48 parts of hexamethylenediamine, 2.78 parts of a 24% aqueous NaOH solution, and 2.91 parts of distilled water was stirred at room temperature to prepare a diamine cross-linking agent mixture. The diamine cross-linking agent mixture was added dropwise to the polysuccinimide dispersion. Stirring was continued after the completion of the dropwise addition, thereby preparing a gel composition. The elastic modulus measurement at every predetermined reaction time indicated a storage elastic modulus of 800 Pa at a reaction time of 60 minutes and a storage elastic modulus of 820 Pa at a reaction time of 180 minutes. After a reaction time of 180 minutes, the gel shape was retained.

The resulting gel composition was washed with methanol, dried in vacuum at 60° C., ground in a mortar, and sifted with a stainless steel sieve (JIS Z-8801) so as to have a particle size of 150 to 710 μm. The water absorbency and the water retentivity were measured to be 13.9 g/g and 8.9 g/g, respectively. It is presumed that it was difficult to prepare a gel having a designed degree of crosslinking by crosslinking with diamine in water and thus the product had low water absorbency and low water retentivity.

TABLE 1

| | | | | | | Comparative | Comparative |
|---|---|---|---|---|---|---|---|
| | | | Example 1 | Example 2 | Example 3 | example 1 | example 2 |
| Reaction | Polysuccinimide (PSI) (parts by mass) | | 10 | 10 | 10 | | 2 |
| product | Compound (A) (parts by mass) | L-Lysine | 2.23 | | | | |
| (P1) of PSI | | L-Ornithine | | 2.6 | | | |
| and (A) | | monohydrochloride | | | | | |
| | | Phosphorylethanolamine | | | 2.18 | | |
| | Evaluation of reaction | Addition percentage (%) | 9.2 | 10.1 | 5.5 | | |
| | product (P1) of PSI and (A) | Solid content (%) | 43 | 50 | 38 | | |
| Cross-linked | Aqueous solution of reaction product (P1) of PSI and (A) | | 4.64 | 5.73 | 5.50 | | |
| poly(aspartic | (parts by mass) | | | | | | |
| acid) product | Aqueous solution of hydrolysate of PSI (solid content: 30%) | | | | | 5.43 | |
| | (parts by mass) | | | | | | |
| | Polyfunctional epoxy | EX-810 | 0.106 | 0.148 | 0.445 | 0.135 | |
| | compound (B) (parts by mass) | | | | | | |
| | Symmetric diamine (A′) | Hexamethylenediamine | | | | | 0.48 |
| | (parts by mass) | | | | | | |
| | Evaluation of cross-linked | Elastic modulus (60 min) | 1100 | 680 | 1250 | 42.2 | 800 |
| | poly(aspartic acid) product | Elastic modulus (120 min) | | | | 1510 | |
| | | Elastic modulus (180 min) | 1180 | 730 | 1310 | 6.7 | 820 |
| | | Shape after 180 min | gel shape | gel shape | gel shape | liquefied | gel shape |
| | | (visual observation) | was retained | was retained | was retained | | was retained |
| | | Water absorbency (g/g) | 45.5 | 46 | 40.8 | unmeasurable | 13.9 |
| | | Water retentivity (g/g) | 29.1 | 31.2 | 29 | unmeasurable | 8.9 |

### Example 4

### [Water-Absorbent Resin Particles]

The gel composition obtained in Example 1 was freeze-dried. The dry composition was ground in a mortar and sifted with a stainless steel sieve (JIS Z-8801) so as to have a particle size of 150 μm to 710 μm. Then 100 parts of the resulting water-absorbent resin was mixed with 0.5 parts of Aerosil 200 (hydrophilic amorphous silica, available from Nippon Aerosil Co., Ltd.) to produce water-absorbent resin particles. The water absorbency and the water retentivity of the resulting particles were measured and found to be 45.0 g/g and 29.0 g/g, respectively.

### Example 5

### [Absorbent Material and Absorbent Article]

Seventy parts of the water-absorbent resin particles obtained in Example 4 and 30 parts of ground wood pulp were dry-mixed using a mixer. The resulting mixture was subjected to air-laid web formation on a wire screen of 400 mesh (opening size: 38 μm) using an air-laid web forming machine to produce an absorbent material.

Subsequently, a liquid-impermeable sheet composed of a liquid-impermeable polypropylene, the absorbent material, and a liquid-permeable sheet formed of a nonwoven fabric composed of a liquid-permeable polypropylene were bonded to each other in this order using a double-sided tape to produce an absorbent article.

### INDUSTRIAL APPLICABILITY

The present invention can provide a cross-linked poly(aspartic acid) product that can retain the gel shape, water absorbency, water retentivity, and other performance because it does not undergo hydrolysis over time owing to the absence of an ester bond, and a method for producing the cross-linked poly(aspartic acid) product. The cross-linked poly(aspartic acid) product of the present invention can be used for super absorbent resins for diaper applications, sanitary products, cosmetic additives, such as thickeners, and other biodegradable resins (e.g., for agriculture and civil engineering).

1. A cross-linked poly(aspartic acid) product, wherein the cross-linked poly(aspartic acid) product is a reaction product of:
a polysuccinimide (PSI),
a compound (A: a1-A1-a2) containing a first functional group (a1) and a second functional group (a2), and
a polyfunctional epoxy compound (B),
wherein the cross-linked poly(aspartic acid) product contains a PSI-a1(A) bond formed by an addition reaction of the first functional group (a1) with the polysuccinimide (PSI),
the cross-linked poly(aspartic acid) product contains a B-a2(A) bond formed by a reaction of the second functional group (a2) with the polyfunctional epoxy compound (B),
the cross-linked poly(aspartic acid) product contains a cross-linked structure (PABAP) represented by PSI-a1-A1-a2-B-a2-A1-a1-PSI,
the cross-linked structure (PABAP) is partially hydrolyzed, and
wherein the second functional group of the compound (A) does not react with the polysuccinimide (PSI) or is less reactive with the polysuccinimide (PSI) than the first functional group,
the first functional group (a1) is an amino group (NH₂—),
the second functional group (a2) is one or more selected from the group consisting of an amino group (NH₂—) and a phosphonooxy group ((OH)₂P(═O)—O—), and
when the second functional group (a2) is an amino group (NH₂—), the second functional group is less reactive with the polysuccinimide (PSI) than the first functional group (a1).

2. (canceled)

3. The cross-linked poly(aspartic acid) product according to claim 1,
wherein the first functional group (a1) is an amino group (NH₂—), and
the second functional group (a2) is an amino group (NH₂—), and
wherein in the compound (A), the amino group of the second functional group (a2) is an amino group in a structure represented by formula (1): 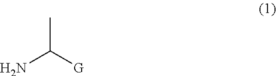
where in formula (1), G is a carboxy acid group or a salt of the carboxylic acid group.

4. The cross-linked poly(aspartic acid) product according to claim 1, wherein the compound (A) is one or more selected from the group consisting of lysine, ornithine, and arginine.

5. A water-absorbent composition, comprising the cross-linked poly(aspartic acid) product according to claim 1.

6. A thickening composition, comprising the cross-linked poly(aspartic acid) product according to claim 1.

7. A method for producing a cross-linked poly(aspartic acid) product, comprising a step of:
forming a cross-linked product by allowing a polysuccinimide (PSI) to react with a compound (A: a1-A1-a2) containing a first functional group (a1) and a second functional group (a2) and a polyfunctional epoxy compound (B) in water or a water-containing solvent,
wherein the second functional group of the compound (A) does not react with the polysuccinimide (PSI) or is less reactive with the polysuccinimide (PSI) than the first functional group,
the first functional group (a1) is an amino group (NH₂—),
the second functional group (a2) is one or more selected from the group consisting of an amino group (NH₂—) and a phosphonooxy group ((OH)₂P(═O)—O—), and
when the second functional group (a2) is an amino group (NH₂—), the second functional group is less reactive with the polysuccinimide (PSI) than the first functional group (a1).

8. (canceled)

9. The method for producing a cross-linked poly(aspartic acid) product according to claim 7,
wherein the first functional group (a1) is an amino group (NH₂—), and
the second functional group (a2) is an amino group (NH₂—), and
wherein in the compound (A), the amino group of the first functional group (a1) is an amino group in NH₂—CH₂—, and the amino group of the second functional group (a2) is an amino group in a structure represented by formula (1): 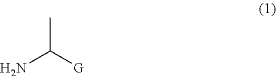
where in formula (1), G is a carboxylic acid group or a salt of the carboxy acid group.

10. The method for producing a cross-linked poly(aspartic acid) product according to claim 7, wherein the compound (A) is one or more selected from the group consisting of lysine, ornithine, and arginine.

11. A water-absorbent resin containing a cross-linked poly(aspartic acid) product according to claim 1.

12. Water-absorbent resin particles containing the water absorbent resin of claim 11.

13. The water-absorbent resin particles as claimed in claim 12, and a fiber layer containing fibers and an absorber.

14. An absorbent article provided with a liquid-impermeable sheet, and the absorber as claimed in claim 13, and a liquid-permeable sheet,
the absorbent article in which the liquid-impermeable sheet, the absorber and the liquid-permeable sheet are arranged in this order.

15. The cross-linked poly(aspartic acid) product according to claim 3, wherein the compound (A) is one or more selected from the group consisting of lysine, ornithine, and arginine.

16. A water-absorbent composition, comprising the cross-linked poly(aspartic acid) product according to claim 3.

17. A water-absorbent composition, comprising the cross-linked poly(aspartic acid) product according to claim 4.

18. A thickening composition, comprising the cross-linked poly(aspartic acid) product according to claim 3.

19. A thickening composition, comprising the cross-linked poly(aspartic acid) product according to claim 4.

20. The method for producing a cross-linked poly(aspartic acid) product according to claim 9, wherein the compound (A) is one or more selected from the group consisting of lysine, ornithine, and arginine.

21. A water-absorbent resin containing a cross-linked poly(aspartic acid) product according to claim 3.

22. A water-absorbent resin containing a cross-linked poly(aspartic acid) product according to claim 4.
